(19) United States
(12) Patent Application Publication
(10) Pub. No.: US 2026/0351476 A1
(43) Pub. Date: Nov. 5, 2026

(54) MULTILAYER CERAMIC CAPACITOR

(71) Applicant: Murata Manufacturing Co., Ltd., Nagaokakyo-shi (JP)

(72) Inventors: Tatsunori YASUDA, Nagaokakyo-shi (JP); Kouhei SEMASA, Nagaokakyo-shi (JP)

(21) Appl. No.: 19/733,132

(22) Filed: Jul. 7, 2026

Related U.S. Application Data
(63) Continuation of application No. PCT/JP2024/033793, filed on Sep. 24, 2024.

(30) Foreign Application Priority Data
Jan. 12, 2024 (JP) 2024-003116

(51) Int. Cl. H01G 4/008; H01G 4/12; H01G 4/232; H01G 4/248; H01G 4/30

(52) U.S. Cl. CPC H01G 4/008; H01G 4/12; H01G 4/232; H01G 4/30; H01G 4/248

(57) ABSTRACT

A multilayer ceramic capacitor a laminate including dielectric layers and internal electrodes, a first external electrode on a third surface of the laminate, and a second external electrode on a fourth surface of the laminate. The laminate includes an inner layer portion including first internal electrodes each with one end exposed at the third surface, a second internal electrode with one end exposed at the fourth surface, inner-layer dielectric layers between the first internal electrodes and the second internal electrode, and a first connection portion connecting the first internal electrodes to each other. The first connection portion is positioned at end portions of the first internal electrodes on a fifth surface side and at end portions of the first internal electrodes on a sixth surface side.

### CROSS REFERENCE TO RELATED APPLICATIONS

This application claims the benefit of priority to Japanese Patent Application No. 2024-003116 filed on Jan. 12, 2024 and is a Continuation Application of PCT Application No. PCT/JP2024/033793 filed on Sep. 24, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor includes an inner layer portion in which dielectric layers and internal electrodes are alternately laminated, and an outer layer portion disposed so as to allow the inner layer portion to be interposed between parts of the outer layer portion. Since the dielectric layers and the internal electrodes are laminated in the inner layer portion, the adhesion strength between different materials may be insufficient, resulting in a risk of interlayer separation.

In order to increase the capacitance of a multilayer ceramic capacitor, there is a known technique in which a laminated portion of a laminate is produced by cutting so that end portions of internal electrodes included in an inner layer portion are aligned, and a side margin portion is provided on a cut surface of the laminated portion. However, when the side margin portion is provided, various problems arise, such as the occurrence of cracks at an interface between the side margin portion and the laminated portion, and separation of the side margin portion from the laminated portion. Therefore, for example, Japanese Unexamined Patent Application Publication No. 2019-79977 addresses problems such as cracking and separation by disposing a connecting portion extending in a z-axis direction from end portions of the internal electrodes in a y-axis direction, in consideration of separation caused by a difference in sintering temperature between the laminated portion including the internal electrodes and the side margin portion. The connecting portion is formed, in a manufacturing process of the multilayer ceramic capacitor disclosed in Japanese Unexamined Patent Application Publication No. 2019-79977, by firing an extended portion obtained by extending end portions of the internal electrodes in the z-axis direction, which is a push-cutting direction of a push-cut blade.

### SUMMARY OF THE INVENTION

However, in the configuration and manufacturing method of the multilayer ceramic capacitor described in Japanese Unexamined Patent Application Publication No. 2019-79977, the distance between two internal electrodes adjacent to each other in the z-axis direction becomes small, thereby making dielectric breakdown more likely to occur. Furthermore, in order to form the connecting portion, the length of the extended portion is varied depending on the shape of a blade. However, as the thickness of the ceramic layer becomes smaller, there is a limit to varying the length of the extended portion by the projections and recesses of the blade.

Accordingly, example embodiments of the present invention provide multilayer ceramic capacitors each capable of reducing or preventing separation in the lamination direction between internal electrodes while reducing or preventing deterioration of insulation resistance.

A multilayer ceramic capacitor according to an example embodiment of the present invention includes a laminate including a plurality of laminated dielectric layers and a plurality of laminated internal electrodes, a first surface and a second surface opposite to each other in a lamination direction, a third surface and a fourth surface opposite to each other in a first direction perpendicular to the lamination direction, and a fifth surface and a sixth surface opposite to each other in a second direction perpendicular to the lamination direction and the first direction. The multilayer ceramic capacitor also includes a first external electrode on the third surface of the laminate, and a second external electrode on the fourth surface of the laminate. The laminate includes an inner layer portion including first internal electrodes, each of the first internal electrodes including one end exposed at the third surface, a second internal electrode including one end exposed at the fourth surface, inner-layer dielectric layers between the first internal electrodes and the second internal electrode, and a first connection portion connecting the first internal electrodes to each other. The first connection portion is positioned at end portions of the first internal electrodes on a fifth surface side and at end portions of the first internal electrodes on a sixth surface side.

In a multilayer ceramic capacitor according to an example embodiment of the present invention, the laminate includes the inner layer portion, and the inner layer portion includes the first internal electrodes each of which has one end exposed at the third surface, the second internal electrode having one end exposed at the fourth surface, the inner-layer dielectric layers between the first internal electrodes and the second internal electrode, and the first connection portion connecting the first internal electrodes to each other. The first connection portion is positioned at the end portions of the first internal electrodes on the fifth surface side and at the end portions of the first internal electrodes on the sixth surface side. Thus, the dielectric layer is interposed between the first internal electrodes using the first connection portion, and accordingly, separation between the internal electrodes in the lamination direction can be reduced or prevented while reducing or preventing deterioration of insulation resistance.

According to example embodiments of the present invention, multilayer ceramic capacitors each capable of reducing or preventing separation in the lamination direction between internal electrodes while reducing or preventing deterioration of insulation resistance can be provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to an example embodiment of the present invention.

FIG. 2 is a plan view illustrating the example of a multilayer ceramic capacitor according to an example embodiment of the present invention.

FIG. 3 is a sectional view taken along line III-III illustrated in FIG. 1.

FIG. 4 is a sectional view taken along line IV-IV illustrated in FIG. 1.

FIG. 5 is a sectional view taken along line V-V illustrated in FIG. 1.

FIG. 6 is a sectional view taken along line VI-VI illustrated in FIG. 2.

FIG. 7 is a sectional view taken along line VII-VII illustrated in FIG. 2.

FIG. 8 is a sectional view taken along line VIII-VIII illustrated in FIG. 2.

FIG. 9 is a sectional view taken along line IX-IX illustrated in FIG. 2.

FIG. 10 is a sectional view taken along line X-X illustrated in FIG. 2.

FIG. 11 is a sectional view taken along line XI-XI illustrated in FIG. 2.

FIG. 12 is a sectional view illustrating a modification in the sectional view illustrated in FIG. 6.

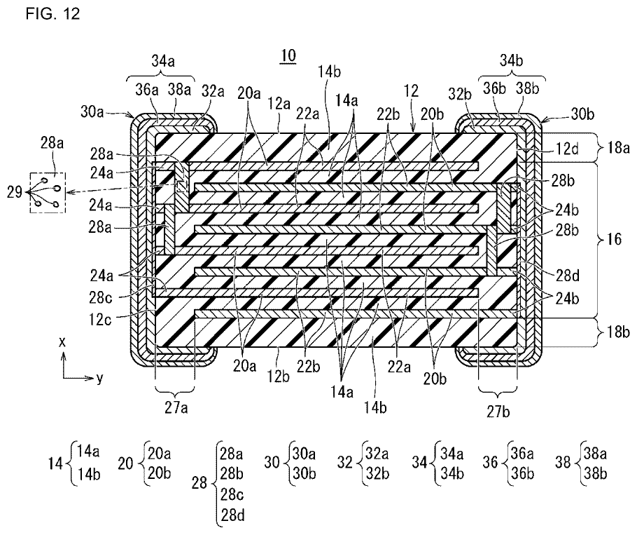

FIG. 13 is a sectional view taken along line III-III illustrated in FIG. 1 schematically illustrating a state of disposition of third and fourth internal electrodes.

### DETAILED DESCRIPTION OF THE EXAMPLE EMBODIMENTS

Multilayer ceramic capacitors according to an example embodiments of the present invention are described.

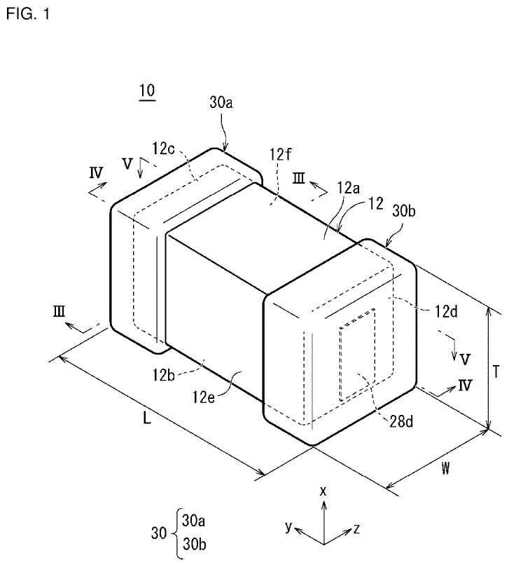

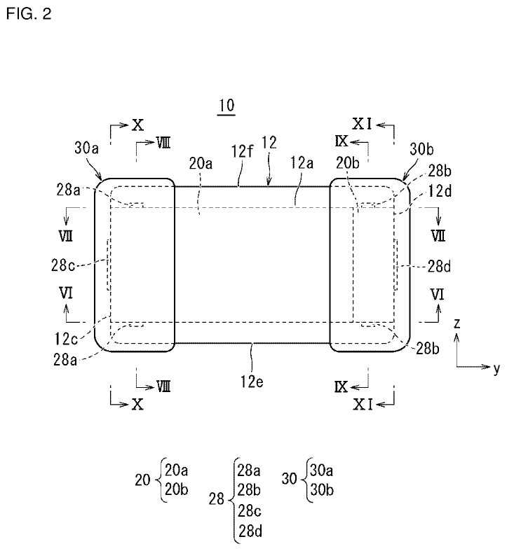

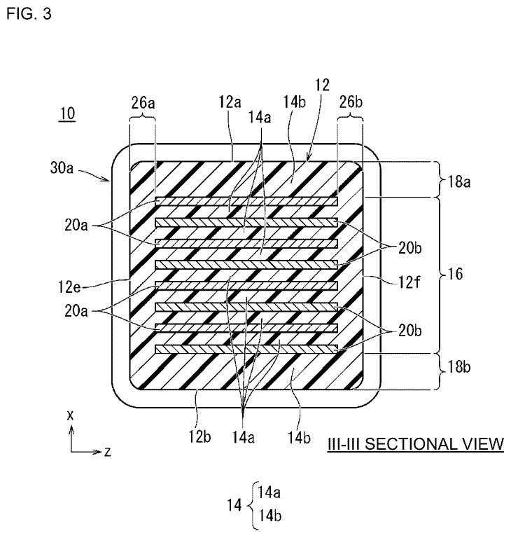

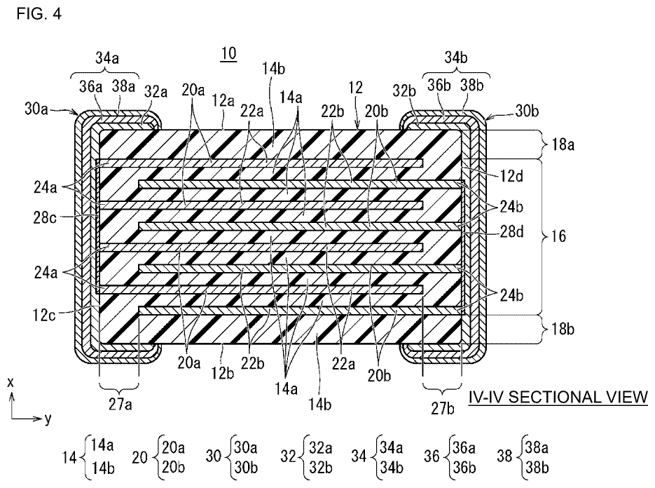

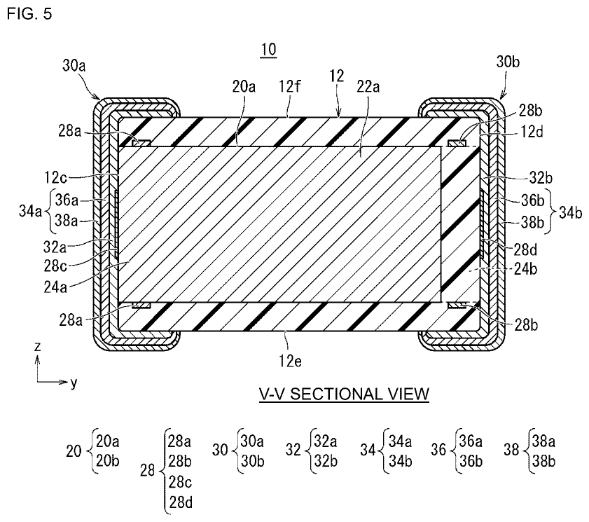

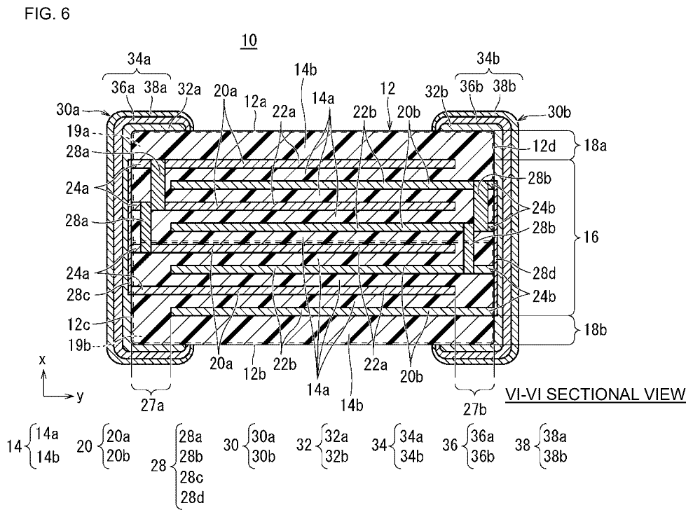

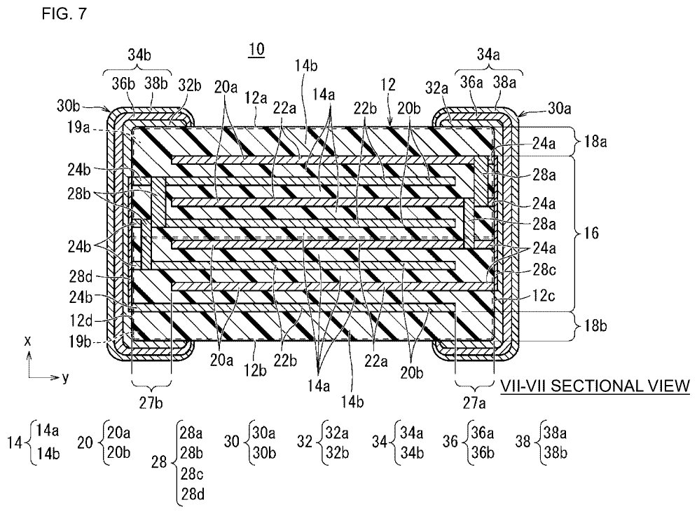

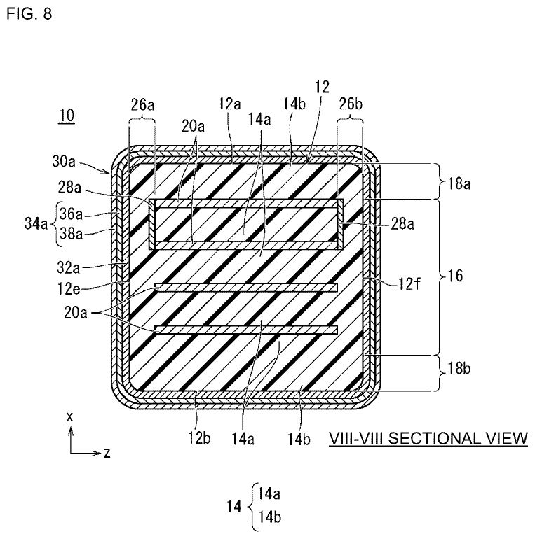

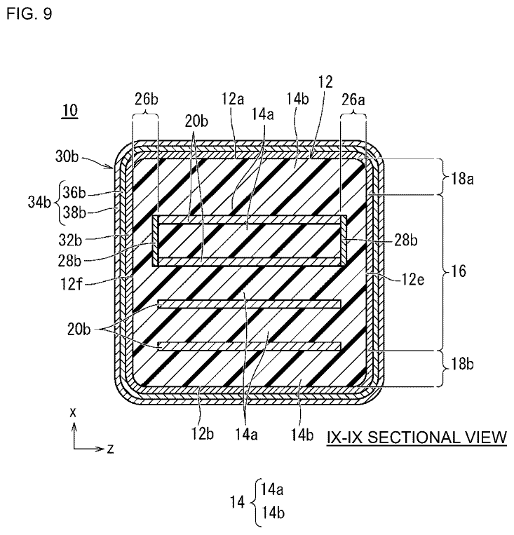

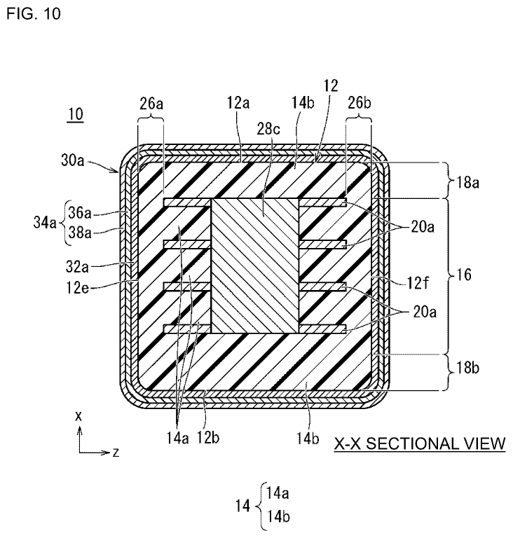

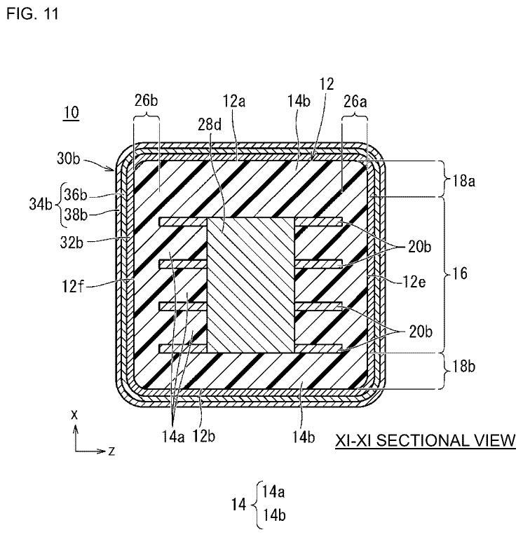

FIG. 1 is an external perspective view illustrating an example of a multilayer ceramic capacitor according to an example embodiment of the present invention. FIG. 2 is a plan view illustrating an example of a multilayer ceramic capacitor according to an example embodiment of the present invention. FIG. 3 is a sectional view taken along line III-III illustrated in FIG. 1. FIG. 4 is a sectional view taken along line IV-IV illustrated in FIG. 1. FIG. 5 is a sectional view taken along line V-V illustrated in FIG. 1. FIG. 6 is a sectional view taken along line VI-VI illustrated in FIG. 2. FIG. 7 is a sectional view taken along line VII-VII illustrated in FIG. 2. FIG. 8 is a sectional view taken along line VIII-VIII illustrated in FIG. 2. FIG. 9 is a sectional view taken along line IX-IX illustrated in FIG. 2. FIG. 10 is a sectional view taken along line X-X illustrated in FIG. 2. FIG. 11 is a sectional view taken along line XI-XI illustrated in FIG. 2.

As illustrated in FIGS. 1 to 4, a multilayer ceramic capacitor 10 includes a laminate 12 having a rectangular parallelepiped shape and external electrodes 30 disposed in both of end portions of the laminate 12.

The laminate 12 includes a plurality of laminated dielectric layers 14 and a plurality of internal electrodes 20 laminated on the dielectric layers 14. Furthermore, the laminate 12 includes a first surface 12a and a second surface 12b opposite to each other in a lamination direction x, a third surface 12c and a fourth surface 12d opposite to each other in a first direction y perpendicular to the lamination direction x, and a fifth surface 12e and a sixth surface 12f opposite to each other in a second direction z perpendicular to the lamination direction x and the first direction y.

Preferably, both of the first surface 12a and the second surface 12b or one of the first surface 12a or the second surface 12b is flat. When both or one of these surfaces is flat, stress received from a nozzle that picks up the multilayer ceramic capacitor 10 can be distributed by a flat surface. As a result, the strength of the multilayer ceramic capacitor can be improved during mounting of the multilayer ceramic capacitor.

The surfaces of the laminate 12 may be roughened.

The corner portions and edge portions of the laminate 12 may be rounded. Portions where two surfaces out of the first surface 12a, the second surface 12b, the third surface 12c, the fourth surface 12d, the fifth surface 12e, and the sixth surface 12f intersect are referred to as the edge portions, and portions where three surfaces out of these surfaces intersect are referred to as the corner portions. Preferably, the edge portions and corner portions are rounded. When the edge portions and corner portions are rounded, in the edge portions and the corner portions can be prevented. When the edge portions and corner portions are rounded, the main surfaces may be flat in surfaces excluding the edge portions and the corner portions.

As illustrated in FIGS. 3 and 4, the laminate 12 includes, in the lamination direction x connecting the first surface 12a and the second surface 12b to each other, an inner layer portion 16, a first surface side outer layer portion 18a, and a second surface side outer layer portion 18b. The inner layer portion 16 is formed by alternately laminating the dielectric layers 14 and the internal electrodes 20. The first surface side outer layer portion 18a is formed by a plurality of dielectric layers 14 positioned between the first surface 12a and an internal electrode 20 positioned closest to the first surface 12a. The second surface side outer layer portion 18b is formed by a plurality of dielectric layers 14 positioned between the second surface 12b and an internal electrode 20 positioned closest to the second surface 12b.

The inner layer portion 16 includes a plurality of inner dielectric layers 14a out of the plurality of dielectric layers 14. That is, a plurality of internal electrodes 20 are disposed in the inner layer portion 16 so as to face each other via the inner dielectric layers 14a.

For example, when the inner dielectric layers 14a include a large amount of CaTiO₃ or CaZrO₃ as a main component of the dielectric material, the occurrence of dielectric breakdown between the internal electrodes 20 can be reduced or prevented. This is not limiting. A material such as SrTiO₃ may also be used as the main component. In order to increase the capacitance of the multilayer ceramic capacitor 10, the inner dielectric layers 14a are preferably formed of a material having a high dielectric constant, such as BaTiO₃, as the main component of the dielectric material. When the above-described dielectric material is included as the main component, secondary components having a content smaller than that of the main component, such as an Mn compound, an Fe compound, a Cr compound, a Co compound, or an Ni compound, or the like may be added in accordance with the desired characteristics of the laminate 12.

The thickness of the dielectric layers 14 after firing is preferably greater than or equal to about 0.5 μm and smaller than or equal to about 10 μm, for example. The number of the dielectric layers 14 to be laminated is preferably greater than or equal to 50 and smaller than or equal to 1000, for example.

As illustrated in FIGS. 3 and 4, the internal electrodes 20 include first internal electrodes 20a and second internal electrodes 20b. The first internal electrodes 20a and the second internal electrodes 20b are alternately laminated via the dielectric layers 14.

The first internal electrodes 20a are on the dielectric layers 14 and positioned inside the laminate 12. Each of the first internal electrodes 20a includes a first extension electrode portion 24a and a first facing electrode portion 22a facing the second internal electrodes 20b. The first extension electrode portion 24a is positioned on the one end side of the first internal electrode 20a and extends from the first facing electrode portion 22a to the third surface 12c of the laminate 12. The first extension electrode portion 24a has an end portion that extends to a front side of the third surface 12c so as to be exposed from the laminate 12. That is, an end portion of the first extension electrode portion 24a is exposed at none of the first surface 12a, the second surface 12b, the fourth surface 12d, the fifth surface 12e, and the sixth surface 12f. An end portion of the first internal electrode portion 20a on the fourth surface 12d side is slightly recessed from the fourth surface 12d.

Although the shape of the first facing electrode portion 22a of the first internal electrode 20a is not particularly limited, the shape is preferably a rectangular shape in plan view. However, the corner portions may be rounded in plan view, or the corner portions may be formed to be inclined (tapered) in plan view. Alternatively, a tapered shape in plan view that becomes inclined toward one of the directions may be used.

Although the shape of the first extension electrode portion 24a of the first internal electrode 20a is not particularly limited, the shape is preferably a rectangular shape in plan view.

The width of the first facing electrode portion 22a of the first internal electrode 20a and the width of the first extension electrode portion 24a of the first internal electrode 20a may be the same, or one of the widths may be smaller than the other.

The second internal electrodes 20b are on the dielectric layers 14 and positioned inside the laminate 12. Each of the second internal electrodes 20b includes a second extension electrode portion 24b and a second facing electrode portion 22b facing the first internal electrodes 20a. The second extension electrode portion 24b is positioned on the one end side of the second internal electrode 20b and extends from the second facing electrode portion 22b to the fourth surface 12d of the laminate 12. The second extension electrode portion 24b has an end portion that extends to a front side of the fourth surface 12d so as to be exposed from the laminate 12. That is, an end portion of the second extension electrode portion 24b is exposed at none of the first surface 12a, the second surface 12b, the third surface 12c, the fifth surface 12e, and the sixth surface 12f. An end portion of the second internal electrode 20b on the third surface 12c side is slightly recessed from the third surface 12c.

Although the shape of the second facing electrode portion 22b of the second internal electrode 20b is not particularly limited, the shape is preferably a rectangular shape in plan view. However, the corner portions may be rounded in plan view, or the corner portions may be formed to be inclined (tapered) in plan view. Alternatively, a tapered shape in plan view that becomes inclined toward one of the directions may be used.

Although the shape of the second extension electrode portion 24b of the second internal electrode 20b is not particularly limited, the shape is preferably a rectangular shape in plan view.

The width of the second facing electrode portion 22b of the second internal electrode 20b and the width of the second extension electrode portion 24b of the second internal electrode 20b may be the same, or one of the widths may be smaller than the other.

The laminate 12 includes a side portion 26a of the laminate 12 and a side portion 26b of the laminate 12. The side portion 26a is between the fifth surface 12e and ends of the first facing electrode portion 22a and the second facing electrode portion 22b on one side in the second direction z. The side portion 26b is between the sixth surface 12f and ends of the first facing electrode portion 22a and the second facing electrode portion 22b on the other side in the second direction z. The laminate 12 further includes an end side portion 27a of the laminate 12 and an end portion 27b of the laminate 12. The end portion 27a is between the fourth surface 12d and an end portion of the first internal electrode 20a on a side opposite from the first extension electrode portion 24a. The end portion 27b is between the third surface 12c and an end portion of the second internal electrode 20b on a side opposite from the second extension electrode portion 24b.

The internal electrodes 20 can be formed of an appropriate conducting material such as Ni, Cu, Ag, Pd, Au or other types of metal or, for example, an alloy such as an Ag—Pd alloy including at least one of such types of metal. The internal electrode 20 may further include dielectric particles of the same composition system as that of the ceramic included in the dielectric layers 14. When Sn is included in the first internal electrodes 20a and the second internal electrodes 20b, concentration of electric fields in interfaces between the internal electrodes 20 and the dielectric layers 14 can be reduced. This leads to improvement of reliability under a high-temperature load. At this time, it is sufficient that Sn be included in either the first internal electrodes 20a or the second internal electrodes 20b.

The thickness of the internal electrodes 20 is preferably greater than or equal to about 0.2 μm and smaller than or equal to about 2.0 μm, for example. The total number of the first internal electrodes 20a and the second internal electrodes 20b is preferably greater than or equal to 50 and smaller than or equal to 1000, for example.

As illustrated in FIGS. 5 to 9, the inner layer portion 16 includes connection portions 28. The connection portions 28 include first connection portions 28a connecting the first internal electrodes 20a to each other and second connection portions 28b connecting the second internal electrodes 20b to each other.

The first connection portions 28a preferably connect end portions of the first internal electrodes 20a on the fifth surface 12e side to each other and end portions of the first internal electrodes 20a on the sixth surface 12f side to each other.

The second connection portions 28b preferably connect end portions of the second internal electrodes 20b on the fifth surface 12e side to each other and end portions of the second internal electrodes 20b on the sixth surface 12f side to each other.

In this way, when the side portions 26a and 26b are formed by a pasting process separately, which will be described later, in a manufacturing process of the multilayer ceramic capacitor 10, adhesion strength between the side portions 26a and 26b and the internal electrodes 20 and adhesion strength between the side portions 26a and 26b and the inner dielectric layers 14a can be improved. As a result, separation between the side portions 26a and 26b and the internal electrodes 20 and separation between the side portions 26a and 26b and the inner dielectric layers 14a can be reduced or prevented. Furthermore, the internal electrodes 20 adjacent to each other in the lamination direction x can be connected to each other via the inner dielectric layers 14a. Thus, separation between the inner dielectric layers 14a and the internal electrodes 20 in the lamination direction x can be reduced or prevented.

It is sufficient that the first connection portions 28a connect the end portions of the first internal electrodes 20a to each other on at least one of the fifth surface 12e side or the sixth surface 12f. Likewise, it is sufficient that the second connection portions 28b connect the end portions of the second internal electrodes 20b to each other on at least one of the fifth surface 12e side or the sixth surface 12f.

The first connection portions 28a preferably connect end portions of the first extension electrode portions 24a of the first internal electrodes 20a on the fifth surface 12e side to each other and end portions of the first extension electrode portion 24a of the first internal electrodes 20a on the sixth surface 12f side to each other. In this case, no first connection portion 28a is provided for the first facing electrode portions 22a.

Likewise, the second connection portions 28b preferably connect end portions of the second extension electrode portions 24b of the second internal electrodes 20b on the fifth surface 12e side to each other and end portions of the second extension electrode portion 24b of the second internal electrodes 20b on the sixth surface 12f side to each other. In this case, no second connection portion 28b is provided for the second facing electrode portions 22b.

Thus, even when the first connection portions 28a are provided, the first internal electrodes 20a adjacent to each other are in the same potential. Also, even when the second connection portions 28b are provided, the second internal electrodes 20b adjacent to each other are in the same potential. Accordingly, separation between the side portions 26a and 26b and the internal electrodes 20 and separation between the side portions 26a and 26b and the inner dielectric layers 14a can be reduced or prevented without reducing insulation resistance.

Preferably, none of the first connection portions 28a are exposed at the front side of the third surface 12c, and preferably, none of the second connection portions 28b are exposed at the front side of the fourth surface 12d.

Thus, the connection portions 28 can be disposed without increasing the distance to reach the internal electrodes 20, and accordingly, deterioration of moisture resistance can be reduced or prevented when moisture penetrates from the outside.

As illustrated in FIGS. 6 and 7, when the laminate 12 is equally bifurcated in the lamination direction x, a region on the first surface 12a side is defined as a first surface side region 19a and a region on the second surface 12b side is defined as a second surface side region 19b. At this time, the connection portions 28 are preferably provided more in the first surface side region 19a. Alternatively, when the laminate 12 is equally bifurcated in the lamination direction x, the connection portions 28 may be provided in one of the first surface side region 19a and the second surface side region 19b. Here, in a manufacturing process of the laminate 12, which will be described later, a bonding force between the inner dielectric layers 14a and the internal electrodes 20 varies between the beginning and end of lamination. Thus, when it is assumed that the first surface 12a side is the lamination end side, the connection portions 28 are preferably provided more in the first surface side region 19a than in the second surface side region 19b. In this way, the connection portions 28 can be on a side where the bonding force between the inner dielectric layers 14a and the internal electrodes 20 is comparatively weak. Accordingly, separation between the inner dielectric layers 14a and the internal electrodes 20 can be further reduced or prevented.

Preferably, two or more connection portions 28 are provided for a single internal electrode 20. The connection portions 28 are preferably positioned nonlinearly in the lamination direction x.

In the multilayer ceramic capacitor 10 according to the present example embodiment, it is sufficient that only the first connection portions 28a be provided as the connection portions 28.

Furthermore, as illustrated in FIGS. 10 and 11, the connection portions 28 included in the inner layer portion 16 may include a third connection portion 28c connecting the first internal electrodes 20a to each other and a fourth connection portions 28d connecting the second internal electrodes 20b to each other. Accordingly, the multilayer ceramic capacitor 10 does not necessarily include the third connection portion 28c or the fourth connection portion 28d.

The third connection portion 28c is preferably exposed at the third surface 12c to connect the first extension electrode portions 24a of the plurality of first internal electrodes 20a exposed at the third surface 12c to each other. Furthermore, the third connection portion 28c is preferably disposed inside end portions in the first extension electrode portions 24a of the first internal electrodes 20a in a direction connecting the fifth surface 12e and the sixth surface 12f (second direction z) to each other.

The fourth connection portion 28d is preferably exposed at the fourth surface 12d to connect the second extension electrode portions 24b of the plurality of second internal electrodes 20b exposed at the fourth surface 12d to each other. Furthermore, the fourth connection portion 28d is preferably disposed inside end portions in the second extension electrode portions 24b of the second internal electrodes 20b in a direction connecting the fifth surface 12e and the sixth surface 12f (second direction z) to each other.

This improves a rate of the metal component on at least one of the third surface 12c or the fourth surface 12d, and accordingly, adhesion strength between the external electrodes 30 and the internal electrodes 20 can be improved.

The connection portions 28 can be formed of an appropriate conducting material such as Ni, Cu, Ag, Pd, Au or other types of metal or, for example, an alloy such as an Ag—Pd alloy including at least one of such types of metal. The connection portions 28 may further include dielectric particles of the same composition system as that of the ceramic included in the dielectric layers 14. When the metal component of the same type as that of the internal electrodes 20 is used as the main component, contraction behaviors in a firing process, which will be described later, can be uniformed.

As illustrated in FIG. 11, dielectric regions 29 may be disposed in the first connection portions 28a and the second connection portions 28b. In this case, the dielectric regions 29 are disposed so as to be scattered over the first connection portions 28a and the second connection portions 28b. The dielectric regions 29 include dielectric particles of the same composition system as that of the ceramic included in the dielectric layers 14. Thus, separation between the side portions 26a and 26b and the internal electrodes 20 and separation between the side portions 26a and 26b and the inner dielectric layers 14a can be further reduced or prevented. Furthermore, over-sintering of the connection portions 28 can be inhibited by dielectric powder, and accordingly, interlayer separation due to excessive contraction can be reduced or prevented. Although the particle diameter of the dielectric particles included in the dielectric regions 29 is not particularly limited, the particle diameter may be, for example, greater than or equal to about 0.1 μm and smaller than or equal to about 3.0 μm.

The first surface side outer layer portion 18a is positioned on the first surface 12a side of the laminate 12. The first surface side outer layer portion 18a is an aggregate of a plurality of outer dielectric layers 14b which are a plurality of dielectric layers 14 positioned between the first surface 12a and an internal electrode 20 closest to the first surface 12a.

The second surface side outer layer portion 18b is positioned on the second surface 12b side of the laminate 12. The second surface side outer layer portion 18b is an aggregate of a plurality of outer dielectric layers 14b which are a plurality of dielectric layers 14 positioned between the second surface 12b and an internal electrode 20 closest to the second surface 12b.

A region interposed between the first surface side outer layer portion 18a and the second surface side outer layer portion 18b is the inner layer portion 16.

The first surface side outer layer portion 18a and the second surface side outer layer portion 18b are formed of respective insulating materials. When the first surface side outer layer portion 18a and the second surface side outer layer portion 18b are formed of a dielectric material of the same type as that of the inner dielectric layers 14a, each of the first surface side outer layer portion 18a and the second surface side outer layer portion 18b may include a plurality of outer dielectric layers 14b or a single outer dielectric layer 14b. The inner dielectric layers 14a and the outer dielectric layers 14b may be formed to have different components. For example, the material of the inner dielectric layers 14a may have a higher dielectric constant than that of the outer dielectric layers 14b, and the material of the outer dielectric layers 14b may be a component having a high moisture resistance, a high weather resistance, or high strength.

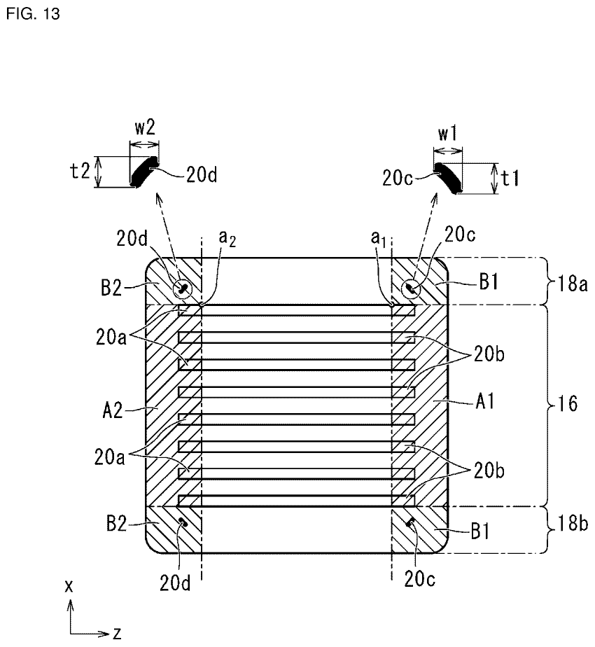

As illustrated in FIG. 13, preferably, the first surface side outer layer portion 18a and the second surface side outer layer portion 18b further include third internal electrodes 20c and fourth internal electrodes 20d that are the same metal type as that of the internal electrodes 20.

Here, as illustrated in FIG. 13, in the inner layer portion 16, a position 20 μm inside in the second direction z from the end portions of the first internal electrodes 20a and the second internal electrodes 20b on the fifth surface 12e side is defined as a1. A region specified in the inner layer portion 16 from a1 to the end portions of the first internal electrodes 20a and the second internal electrodes 20b on the fifth surface 12e side is defined as A1. Regions specified when the region A1 are extended in the lamination direction x in the first surface side outer layer portion 18a and the second surface side outer layer portion 18b are defined as B1. At this time, the third internal electrodes 20c are preferably disposed in the regions B1.

Furthermore, in the inner layer portion 16, a position at about 20 μm inside in the second direction z from the end portions of the first internal electrodes 20a and the second internal electrodes 20b on the sixth surface 12f side is defined as a2. A region specified in the inner layer portion 16 from a2 to the end portions of the first internal electrodes 20a and the second internal electrodes 20b on the sixth surface 12f side is defined as A2. Regions specified when the region A2 is extended in the lamination direction x in the first surface side outer layer portion 18a and the second surface side outer layer portion 18b are defined as B2. At this time, the fourth internal electrodes 20d are preferably disposed in the regions B2.

In this way, penetration of moisture from interfaces between the side portion 26a and the outer layer portions 18a and 18b can be prevented by the third internal electrodes 20c and the fourth internal electrodes 20d. Accordingly, moisture resistance of the multilayer ceramic capacitor 10 can be improved.

When the length of the third internal electrodes 20c in the second direction z is w1, and the length of the third internal electrodes 20c in the lamination direction x is t1, it is preferable that w1<t1.

When the length of the fourth internal electrodes 20d in the second direction z is w2, and the length of the fourth internal electrodes 20d in the lamination direction x is t2, it is preferable that w2<t2.

Furthermore, the third internal electrodes 20c and the fourth internal electrodes 20d are preferably curved so as to be convex toward the outside of the laminate 12.

Thus, neither the third internal electrodes 20c nor the fourth internal electrodes 20d are linearly disposed, and in addition, the length in the lamination direction x is greater than the length in the second direction z. Accordingly, paths of moisture penetrating from the interfaces between the side portion 26a and the outer layer portions 18a and 18b can become long and complex by the third internal electrodes 20c and the fourth internal electrodes 20d. This can further improve the moisture resistance of the multilayer ceramic capacitor 10.

As illustrated in FIGS. 1 to 4, the external electrodes 30 are on the third surface 12c side and the fourth surface 12d side of the laminate 12.

The external electrodes 30 include primary electrode layers 32 including a metal component and glass and plated layers 34 on the surfaces of the primary electrode layers 32.

The external electrodes 30 include a first external electrode 30a and a second external electrode 30b.

The first external electrode 30a is connected to the first internal electrodes 20a and disposed at least on the front side of the third surface 12c. The first external electrode 30a extends from the third surface 12c of the laminate 12 and spreads to a portion of the first surface 12a, a portion of the second surface 12b, a portion of the fifth surface 12e, and a portion of the sixth surface 12f. In this case, the first external electrode 30a is electrically connected to the first extension electrode portions 24a of the first internal electrodes 20a.

The second external electrode 30b is connected to the second internal electrodes 20b and disposed at least on the front side of the fourth surface 12d. The second external electrode 30b extends from the fourth surface 12d of the laminate 12 and spreads to a portion of the first surface 12a, a portion of the second surface 12b, a portion of the fifth surface 12e, and a portion of the sixth surface 12f. In this case, the second external electrode 30b is electrically connected to the second extension electrode portions 24b of the second internal electrodes 20b.

In the laminate 12, the first facing electrode portions 22a of the first internal electrodes 20a and the second facing electrode portions 22b of the second internal electrodes 20b face each other via the dielectric layers 14, thereby generating electrostatic capacitance. Thus, the electrostatic capacitance can be obtained between the first external electrode 30a to which the first internal electrodes 20a are connected and the second external electrode 30b to which the second internal electrodes 20b are connected, and the characteristics of a capacitor emerge.

The primary electrode layers 32 include a first primary electrode layer 32a and a second primary electrode layer 32b.

The first primary electrode layer 32a is connected to the first internal electrodes 20a and on the front side of the third surface 12c. Furthermore, the first primary electrode layer 32a extends from the third surface 12c and spreads to a portion of the first surface 12a, a portion of the second surface 12b, a portion of the fifth surface 12e, and a portion of the sixth surface 12f. In this case, the first primary electrode layer 32a is electrically connected to the first extension electrode portions 24a of the first internal electrodes 20a.

The second primary electrode layer 32b is connected to the second internal electrodes 20b and on the front side of the fourth surface 12d. Furthermore, the second primary electrode layer 32b extends from the fourth surface 12d and spreads to a portion of the first surface 12a, a portion of the second surface 12b, a portion of the fifth surface 12e, and a portion of the sixth surface 12f. In this case, the second primary electrode layer 32b is electrically connected to the second extension electrode portions 24b of the second internal electrodes 20b.

The primary electrode layers 32 each include at least one layer selected from a baked layer, a conductive resin layer, or a thin film layer, or the like.

Hereinafter, configurations of the cases in which the primary electrode layer 32 includes the above-described baked layer, the primary electrode layer 32 includes the above-described conductive resin layer, and the primary electrode layer 32 includes the above-described thin film layer are described.

The baked layer includes a metal component and glass. The metal component of the baked layer includes, for example, at least one of Cu, Ni, Ag, Pd, an Ag—Pd alloy, or Au, or the like. The baked layer is formed by applying a conductive paste including glass and metal to the laminate and baking the applied conductive paste. The baked layer is formed by simultaneously baking a laminated chip including the internal electrodes 20 and the dielectric layers 14 and the conductive paste applied to the laminated chip. However, baking may be performed after the laminated chip including the internal electrodes 20 and the dielectric layers 14 has been fired. The baked layer may include a plurality of layers.

The thickness of the first primary electrode layer 32a positioned on the third surface 12c in the first direction y connecting the third surface 12c and the fourth surface 12d to each other at a central portion in the lamination direction x is preferably, for example, greater than or equal to about 10 μm and smaller than or equal to about 150 μm.

The thickness of the second primary electrode layer 32b positioned on the fourth surface 12d in the first direction y connecting the third surface 12c and the fourth surface 12d to each other at a central portion in the lamination direction x is preferably, for example, greater than or equal to about 10 μm and smaller than or equal to about 150 μm.

The thickness of the first primary electrode layer 32a positioned in a portion of the first surface 12a and a portion of the second surface 12b in the lamination direction x connecting the first surface 12a and the second surface 12b to each other at a central portion in the first direction y connecting the third surface 12c and the fourth surface 12d to each other is preferably, for example, greater than or equal to about 10 μm and smaller than or equal to about 100 μm.

Furthermore, the thickness of the second primary electrode layer 32b positioned in a portion of the first surface 12a and a portion of the second surface 12b in the lamination direction x connecting the first surface 12a and the second surface 12b to each other at a central portion in the first direction y connecting the third surface 12c and the fourth surface 12d to each other is preferably, for example, greater than or equal to about 10 μm and smaller than or equal to about 100 μm.

The thickness of the first primary electrode layer 32a positioned in a portion of the fifth surface 12e and a portion of the sixth surface 12f in the second direction z connecting the fifth surface 12e and the sixth surface 12f to each other at a central portion in the first direction y connecting the third surface 12c and the fourth surface 12d to each other is preferably, for example, greater than or equal to about 10 μm and smaller than or equal to about 100 μm.

Furthermore, the thickness of the second primary electrode layer 32b positioned in a portion of the fifth surface 12e and a portion of the sixth surface 12f in the second direction z connecting the fifth surface 12e and the sixth surface 12f to each other at a central portion in the first direction y connecting the third surface 12c and the fourth surface 12d to each other is preferably, for example, greater than or equal to about 10 μm and smaller than or equal to about 100 μm.

The conductive resin layer includes a first conductive resin layer and a second conductive resin layer.

The first conductive resin layer is preferably disposed, as the first primary electrode layer 32a, so as to further cover other layers such as the baked layer, and the second conductive resin layer is preferably disposed, as the second primary electrode layer 32b, so as to further cover other layers such as the baked layer.

Specifically, the first conductive resin layer and the second conductive resin layer, which are respectively serving as the first primary electrode layer 32a and the second primary electrode layer 32b, are preferably provided so as to be on other layers such as the baked layer positioned on the third surface 12c and the fourth surface 12d and so as to reach regions on other layers such as the baked layer positioned on the first surface 12a, the second surface 12b, the fifth surface 12e, and the sixth surface 12f. Alternatively, the first conductive resin layer and the second conductive resin layer may be only on other layers such as the baked layer positioned on the third surface 12c and the fourth surface 12d.

Preferably, the thickness of the first conductive resin layer and the second conductive resin layer is preferably, for example, greater than or equal to about 10 μm and smaller than or equal to about 200 μm.

The first conductive resin layer and the second conductive resin layer include thermosetting resin and a metal component.

The first conductive resin layer and the second conductive resin layer include thermosetting resin. Accordingly, for example, the first conductive resin layer and the second conductive resin layer are rich in flexibility compared to the primary electrode layers 32 including a plated film and fired conductive paste. For this reason, even when physical impact or impact caused by thermal cycles is applied to the multilayer ceramic capacitor 10, the conductive resin layer functions as a buffer layer. Accordingly, cracks in the multilayer ceramic capacitor 10 can be prevented.

Specific examples of the thermosetting resin include, for example, various types of well-known thermosetting resin such as epoxy resin, phenol resin, urethane resin, silicone resin, and polyimide resin. Among these, epoxy resin having a high heat resistance, a high moisture resistance, a good contact property, and the like is one of the most suitable types of resin.

Preferably, the first conductive resin layer and the second conductive resin layer each include a curing agent together with the thermosetting resin. As the curing agent, when epoxy resin is used as base resin, various known compounds of, for example, phenolic, amine, acid anhydride, imidazole curing agents may be used for epoxy resin.

Examples of the metal included in the first conductive resin layer and the second conductive resin layer include Ag, Cu, an alloy of Ag, and an alloy of Cu. Furthermore, metal powder having an Ag-coated surface can be used. When the metal powder having an Ag-coated surface is used, Cu or Ni is preferably used as the metal powder.

Furthermore, Cu having undergone an antioxidizing process can be used. The reason for using an Ag-coated metal is that the cost of the metal of the base material can be reduced while maintaining the characteristics of the Ag.

The rate of the metal included in the first conductive resin layer and the second conductive resin layer is preferably greater than or equal to about 35 vol % and smaller than or equal to about 75 vol % relative to the volume of the entire conductive resin, for example.

The shape of the metal included in the first conductive resin layer and the second conductive resin layer is not particularly limited. Conductive fillers may have a spheric shape, a flattened shape, or the like.

The average particle diameter of the metal included in the first conductive resin layer and the second conductive resin layer is not particularly limited. The average particle diameter of the conductive fillers may be, for example, greater than or equal to about 0.3 μm and smaller than or equal to about 10 μm.

The metal included in the first conductive resin layer and the second conductive resin layer is mainly responsible for current carrying in the conductive resin layers. Specifically, when the conductive fillers are in contact with each other, current carrying paths are formed in the conductive resin layers.

Although the shape of the metal included in the first conductive resin layer and the second conductive resin layer can have a spheric shape, a flattened shape, or the like, preferably, spheric metal powder and flattened metal powder are mixed.

The conductive resin layers may be directly formed on the laminate 12 without forming the baked layers.

Next, a first plated layer 34a and a second plated layer 34b, which are the plated layers 34 on the primary electrode layers 32, are described with reference to FIGS. 2 and 3.

The first plated layer 34a and the second plated layer 34b include, for example, at least one of Cu, Ni, Sn, Ag, Pd, an Ag—Pd alloy, or Au, or the like.

The first plated layer 34a is disposed so as to completely cover the first primary electrode layer 32a.

The second plated layer 34b is disposed so as to completely cover the second primary electrode layer 32b.

The first plated layer 34a and the second plated layer 34b each include a plurality of layers. In this case, preferably, the plated layers 34 each have a two-layer structure including a lower plated layer (Ni plated layer) formed by Ni plating on the primary electrode layer 32 and an upper plated layer (Sn plated layer) formed by Sn plating on the lower plated layer.

That is, in this case, the first plated layer 34a includes a first lower plated layer 36a and a first upper plated layer 38a positioned on the surface of the first lower plated layer 36a.

Furthermore, the second plated layer 34b includes a second lower plated layer 36b and a second upper plated layer 38b positioned on the surface of the second lower plated layer 36b.

The lower plated layers 36 by Ni plating is used to prevent the primary electrode layers 32 from being eroded by solder used in mounting the multilayer ceramic capacitor 10. The upper plated layers 38 by Sn plating is used to facilitate mounting of the multilayer ceramic capacitor 10 by improving solder wettability in mounting the multilayer ceramic capacitor 10.

The thickness per plated layer of the lower plated layers 36 and the upper plated layers 38 is preferably greater than or equal to about 1.0 μm and smaller than or equal to about 15.0 μm, for example.

A dimension of the multilayer ceramic capacitor 10 including the laminate 12, the first external electrode 30a, and the second external electrode 30b in the first direction y is defined as dimension L, a dimension of the multilayer ceramic capacitor 10 including the laminate 12, the first external electrode 30a, and the second external electrode 30b in the lamination direction x is defined as dimension T, and a dimension of the multilayer ceramic capacitor 10 including the laminate 12, the first external electrode 30a, and the second external electrode 30b in the second direction z is defined as dimension W.

The dimensions of the multilayer ceramic capacitor 10 are as follows: the dimension L in the first direction y is greater than or equal to about 0.1 mm and smaller than or equal to about 3.2 mm, the dimension W in the second direction z is greater than or equal to about 0.05 mm and smaller than or equal to about 2.5 mm, and the dimension T in the lamination direction x is greater than about 0.05 mm and smaller than or equal to about 2.5 mm, for example. The dimensions of the multilayer ceramic capacitor 10 can be measured with a microscope.

The multilayer ceramic capacitor 10 illustrated in FIG. 1 includes, in the inner layer portion 16, the first connection portions 28a connecting the first internal electrodes 20a to each other and the second connection portions 28b connecting the second internal electrodes 20b to each other. Accordingly, the internal electrodes 20 adjacent to each other in the lamination direction x can be connected to each other via the inner dielectric layers 14a. Thus, separation between the inner dielectric layers 14a and the internal electrodes 20 in the lamination direction x can be reduced or prevented.

Furthermore, in the multilayer ceramic capacitor 10 illustrated in FIG. 1, when the first connection portions 28a connect the end portions of the first extension electrode portions 24a of the first internal electrodes 20a to each other on the fifth surface 12e side and the sixth surface 12f side and the second connection portions 28b connect the end portions of the second extension electrode portions 24b of the second internal electrodes 20b to each other on the fifth surface 12e side and the sixth surface 12f side, even in the case where the first connection portions 28a are provided, the first internal electrodes 20a adjacent to each other are in the same potential, and even in the case where the second connection portions 28b are provided, the second internal electrodes 20b adjacent to each other are in the same potential. Accordingly, separation between the side portions 26a and 26b and the internal electrodes 20 and separation between the side portions 26a and 26b and the inner dielectric layers 14a can be reduced or prevented without reducing insulation resistance.

Furthermore, in the multilayer ceramic capacitor 10 illustrated in FIG. 1, when none of the first connection portions 28a are exposed at the front side of the third surface 12c and none of the second connection portions 28b are exposed at the front side of the fourth surface 12d, the connection portions 28 can be disposed without increasing the distance to reach the internal electrodes 20, and accordingly, deterioration of moisture resistance can be reduced or prevented.

Furthermore, in the multilayer ceramic capacitor 10 illustrated in FIG. 1, it is assumed that, when the laminate 12 is equally bifurcated in the lamination direction x, the region on the first surface 12a side is defined as the first surface side region 19a and the region on the second surface 12b side is defined as the second surface side region 19b. In this case, by disposing the connection portions 28 more in the first surface side region 19a or in either the first surface side region 19a or the second surface side region 19b, the connection portions 28 can be on the side where the bonding force between the inner dielectric layers 14a and the internal electrodes 20 is comparatively weak. Accordingly, separation between the inner dielectric layers 14a and the internal electrodes 20 can be further reduced or prevented.

Furthermore, in the multilayer ceramic capacitor 10 illustrated in FIG. 1, when the third connection portion 28c is disposed so as to connect the first extension electrode portions 24a of a plurality of the first internal electrodes 20a exposed at the third surface 12c to each other, and the fourth connection portion 28d is disposed so as to connect the second extension electrode portions 24b of a plurality of the second internal electrodes 20b exposed at the fourth surface 12d to each other, the rate of the metal component on at least one of the third surface 12c or the fourth surface 12d can be improved. Accordingly, the adhesion strength between the external electrodes 30 and the internal electrodes 20 can be improved.

Next, an example of a method for manufacturing a multilayer ceramic capacitor is described.

First, a ceramic green sheet for the dielectric layers and conductive paste for the internal electrodes are prepared. The ceramic green sheet and the conductive paste for the internal electrodes include a binder and a solvent. The binder and the solvent may be a well-known binder and a well-known solvent.

The conductive paste for the internal electrodes is printed on the ceramic green sheet for the dielectric layers in a predetermined pattern by, for example, screen printing, gravure printing, or the like. Thus, a ceramic green sheet in which the pattern of the first internal electrode is formed and a ceramic green sheet in which the pattern of the second internal electrode is formed are prepared.

Next, a predetermined number of ceramic green sheets for the outer layers on which no pattern of an internal electrode is printed are laminated, thereby forming a portion to become the second surface side outer layer portion on the second surface side. Then, the ceramic green sheets on which the pattern of the first internal electrode is printed and the ceramic green sheets on which the pattern of the second internal electrode is printed are sequentially laminated on the portion to become the second surface side outer layer portion so as to make a structure according to the present invention, thereby forming a portion to become the inner layer portion. A predetermined number of ceramic green sheets for the outer layers on which no pattern of the internal electrode is printed are laminated on the portion to become the inner layer portion, thereby forming a portion to become the first surface side outer layer portion on the first surface side. In this way, the laminated sheet is produced.

Next, when the laminated sheet is pressed in the lamination direction x by a hydrostatic press or the like, the laminated block is produced.

The laminated block is cut into pieces of a predetermined size, thereby cutting out laminated chips to become the laminated portion. The laminated portion is formed so as to allow edge portions of the internal electrode patterns to be exposed at a side surface parallel to the third surface 12c of the complete laminate 12 and a side surface parallel to the fourth surface 12d of the completed laminate 12.

Here, powder of a metal component that is the same type as the metal component of the internal electrodes to become the connection portions 28 is provided in regions of the internal electrode patterns exposed at both of the side surfaces of the laminated portion. Although the particle diameter of the powder of the metal component is not particularly limited, the particle diameter may be, for example, greater than or equal to about 0.05 μm and smaller than or equal to about 0.50 μm. As illustrated in FIG. 11, when the dielectric regions 29 are disposed in the connection portions 28, the dielectric regions 29 can be formed by mixing powder of a dielectric component in addition to the powder of the metal component that is the same type as the metal component of the internal electrodes. Thus, the connection portions 28 can be disposed so as to be scattered in the lamination direction x.

The connection portions 28 may be formed by applying the paste via a mask having an arbitrary shape. Preferably, the paste is made by, for example, dispersing metal powder and dielectric powder in a solvent. When the connection portions 28 are formed of the paste, positions to dispose the connection portions are limited due to the design of the mask. Thus, it should be noted that the connection portions tend to be linearly disposed in the lamination direction x.

Next, side margin sheets having a predetermined material composition are pasted to the both of the side surfaces of the laminated portion. Thus, side margin portions are formed on both of the side surfaces of the laminated portion, thereby an unfired laminate chip is obtained. At this time, corner portions and edge portions of the laminated portion and the side margin portions may be rounded by barrel polishing or the like.

Next, the laminated chip is fired to produce the laminate. When the laminated chip is fired, the metal component or the metal component and the dielectric component provided in the regions of the internal electrode patterns are sintered, thereby forming the connection portions. The firing temperature, which depends on the temperatures of the dielectric layers or the internal electrodes, is preferably higher than or equal to about 900° C. and lower than or equal to about 1400° C., for example.

Next, the conductive paste for the primary electrode layers including the metal component and the glass component are prepared.

The prepared conductive paste to become the primary electrode layers is applied to both of the end surfaces of the laminate so as to form the primary electrode layers. The conductive paste is applied to both of the end surfaces of the laminate by, for example, using a method such as dipping or screen printing. Preferably, the temperature of a baking process at this time is higher than or equal to about 700° C. and lower than or equal to about 900° C., for example.

Next, the plated layers are formed by applying plating to the surface of each primary electrode layer as required. According to the present example embodiment, two plated layers are formed on the surface of the primary electrode layer. Specifically, the Ni plated layer and the Sn plated layer are formed on the primary electrode layer. The Ni plated layer and the Sn plated layer are sequentially formed by, for example, a barrel plating method.

The multilayer ceramic capacitor 10 according to the present example embodiment is manufactured as described above.

With the method for manufacturing a multilayer ceramic capacitor according to an example embodiment of the present invention, a multilayer ceramic capacitor in which a connection portion is disposed in a predetermined region can be obtained.

As described above, example embodiments of the present invention have been disclosed in the above description, the present invention is not limited to this.

That is, various changes may be made to the example embodiments described above with respect to the mechanism, shape, material, number, position, arrangement, or the like, without departing from the scope of the present invention, and such changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed:

1. A multilayer ceramic capacitor comprising:
a laminate including:
a first surface and a second surface opposite to each other in a lamination direction;
a third surface and a fourth surface opposite to each other in a first direction perpendicular to the lamination direction; and
a fifth surface and a sixth surface opposite to each other in a second direction perpendicular to the lamination direction and the first direction;
a first external electrode on the third surface of the laminate; and
a second external electrode on the fourth surface of the laminate; wherein
the laminate includes an inner layer portion including:
first internal electrodes each including one end exposed at the third surface;
a second internal electrode each including one end exposed at the fourth surface;
inner-layer dielectric layers between the first internal electrodes and the second internal electrode; and
a first connection portion connecting the first internal electrodes to each other; wherein
the first connection portion is positioned at end portions of the first internal electrodes on a fifth surface side.

2. The multilayer ceramic capacitor according to claim 1, wherein
a plurality of the second internal electrodes are provided;
the inner layer portion includes a second connection portion connecting the second internal electrodes to each other; and
the second connection portion is positioned at end portions of the second internal electrodes on a fifth surface side.

3. The multilayer ceramic capacitor according to claim 1, wherein the first connection portion is positioned on a third surface side relative to one end of the second internal electrode on the third surface side.

4. The multilayer ceramic capacitor according to claim 2, wherein the second connection portion is positioned on a fourth surface side relative to one end of the first internal electrode on the fourth surface side.

5. The multilayer ceramic capacitor according to claim 1, wherein the first connection portion is not exposed at the third surface.

6. The multilayer ceramic capacitor according to claim 2, wherein the second connection portion is not exposed at the fourth surface.

7. The multilayer ceramic capacitor according to claim 1, wherein a dielectric region is on the first connection portion.

8. The multilayer ceramic capacitor according to claim 2, wherein a dielectric region is on the second connection portion.

9. The multilayer ceramic capacitor according to claim 2, wherein
a plurality of the second connection portions are provided; and
when the laminate is equally bifurcated in the lamination direction into a region on a first surface side which is defined as a first surface side region and a region on a second surface side which is defined as a second surface side region, the second connection portions are provided more in the first surface side region than in the second surface side region.

10. The multilayer ceramic capacitor according to claim 1, wherein
a plurality of the first connection portions are provided; and
at least two first connection portions are provided for each of the first internal electrodes in the first direction.

11. The multilayer ceramic capacitor according to claim 1, wherein
the laminate includes a third connection portion connecting the first internal electrodes to each other; and
the third connection portion is positioned at end portions of the first internal electrodes on a third surface side.

12. The multilayer ceramic capacitor according to claim 1, wherein
a plurality of the second internal electrodes are provided;
the laminate includes a fourth connection portion connecting the second internal electrodes to each other; and
the fourth connection portion is positioned at end portions of the second internal electrodes on a fourth surface side.

13. The multilayer ceramic capacitor according to claim 1, wherein
a plurality of the first connection portions are provided; and
when the laminate is equally bifurcated in the lamination direction into a region on a first surface side which is defined as a first surface side region and a region on a second surface side which is defined as a second surface side region, the first connection portions are provided more in the first surface side region than in the second surface side region.

14. The multilayer ceramic capacitor according to claim 2, wherein
a plurality of the second connection portions are provided; and
at least two second connection portions are provided for each of the second internal electrodes in the first direction.

15. The multilayer ceramic capacitor according to claim 1, wherein the first connection portion includes dielectric particles with a same composition as that of the inner-layer dielectric layers.

16. The multilayer ceramic capacitor according to claim 2, wherein the second connection portion includes dielectric particles with a same composition as that of the inner-layer dielectric layers.

17. The multilayer ceramic capacitor according to claim 1, wherein two or more of the first connection portion are provided for each single one of the internal electrodes.

18. The multilayer ceramic capacitor according to claim 2, wherein two or more of the second connection portion are provided for each single one of the internal electrodes.

19. The multilayer ceramic capacitor according to claim 1, wherein the first connection portion includes Ni, Cu, Ag, Pd, or Au or an alloy including Ni, Cu, Ag, Pd, or Au.
